(19) United States
(12) Patent Application Publication
(10) Pub. No.: US 2006/0256067 A1
(43) Pub. Date: Nov. 16, 2006

(54) System and method for information handling system ambient light sensor user interface

(76) Inventors: Adolfo S. Montero, Austin, TX (US); James E. Dailey, Round Rock, TX (US)

Correspondence Address: HAMILTON & TERRILE, LLP, P.O. BOX 203518, AUSTIN, TX, 78720, US

(21) Appl. No.: 11/128,690

(22) Filed: May 12, 2005

(51) Int. Cl. G09G 3/36

(52) U.S. Cl. 345/102

(57) ABSTRACT

Ambient light sensor adjustments to the brightness of an information handling system display are further adjusted to compensate for user brightness preferences at various detected ambient light level. User brightness preference adjustments for each of plural detected ambient light levels are manually selected by user configuration inputs or alternatively are automatically determined by analysis of manual user changes in brightness output at the ambient light levels. For instance, a user manual alteration of display brightness at given ambient light level is saved and used for subsequent use when the given ambient light level is detected.

### BACKGROUND OF THE INVENTION

1. Field of the Invention

The present invention relates in general to the field of information handling system displays, and more particularly to a system and method for an information handling system ambient light sensor user interface.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems have become quite popular among users due to the flexibility that they offer. A portable information handling system includes processing components, a display and an internal power source in single housing so that a user may carry the information handling system from place to place while the system is operating. Thus, for instance, a user often carries his portable information handling system from his office to various locations for meetings. The portable information handling system is available for taking notes, storing reference materials and supporting display of presentation materials, such as through a projector. With the increasing availability of wireless networks, portable information handling systems also typically allow the user to remain in communication with others by e-mail and instant messaging as the user moves to various locations. In a typical day, a portable information handling system may travel from a moderately-lit office environment to a dimly-lit conference room and then to an outdoor coffee shop. Generally, as the lighting conditions change, users must manually adjust the brightness of the portable information handling system display to an appropriate level. For instance, during a presentation in a conference room, a user typically adjusts the display brightness down to allow a clear view of the presentation and avoid disturbing others while, at the outdoor coffee shop, a user typically adjusts the display brightness up to overcome the outdoor brightness and make the displayed information visible.

One solution to the manual adjustment of display brightness is the use of an ambient light sensor (ALS) to detect ambient light present at a display and dynamically adjust display brightness based on the detected ambient light levels. For instance, if a user goes from an office environment into a presentation environment, the ambient light sensor detects the decrease in light of the presentation environment relative to the office environment and automatically dims the brightness of the display. Although the ambient light sensor adjusts display brightness levels to adapt for ambient lighting conditions, information handling system users tend to have preferences for display brightness that differ from the automated brightness settings provided by ambient light sensors. Thus, even after an ambient light sensor responds to a change in ambient light by adjusting a display's brightness, users tend to further adjust the brightness manually. The need for additional manual adjustments by users detracts from the user experience and is typically viewed as a nuisance by the user and those around the user who are distracted by the noise and changing brightness that accompanies manual adjustment.

### SUMMARY OF THE INVENTION

Therefore a need has arisen for a system and method which adjusts automated ambient light sensor display brightness changes to the preferences of an information handling system end user.

In accordance with the present invention, a system and method are provided which substantially reduce the disadvantages and problems associated with previous methods and systems for adjusting information handling system display brightness. User brightness preferences are associated with detected ambient light levels so that an information handling system display's brightness compensates for the user preference associated with a detected ambient light level.

More specifically, an ambient light sensor provides sensed ambient light to a brightness adjustment module. The brightness adjustment module outputs a display brightness level to an inverter that compensates for the ambient light. The brightness adjustment module also accepts manual user inputs to change display brightness from the nominal value associated with sensed ambient light to a level manually selected by the user. A brightness preference module interfaced with the brightness adjustment module analyzes user manual brightness inputs to build a user brightness preference table. The user brightness preference table associates user preferences at selected ambient levels with display brightness settings. On subsequent use of the display at an ambient light level that is associated with a user brightness preference, the brightness adjustment module applies the user preference brightness to display the information.

The present invention provides a number of important technical advantages. One example of an important technical advantage is that users who achieve a desired display brightness setting for a given ambient light level will have that display brightness setting automatically set when the given ambient light level is detected. Thus, ambient light brightness adjustments are managed more effectively by a user to enhance the user experience. Automated determination and application of user brightness preferences minimizes user interaction with brightness settings, presenting less chance for confusion by users, however, more sophisticated users have the option of directly setting brightness preferences for various ambient light environments.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having a display with ambient light brightness correction;

FIG. 2 depicts a block diagram of a system for adjusting display ambient light brightness correction for user brightness preferences;

FIG. 3 depicts a functional block diagram of an example of an automated user brightness preference adjustment to a display having ambient light correction; and

FIG. 4 depicts an example of a comparison of ambient light correction with and without user brightness preference adjustments.

### DETAILED DESCRIPTION

Information handling system display brightness adjustments compensate for both ambient light levels and user brightness preferences at various ambient light levels to provide improved display brightness management with reduced direct user involvement. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

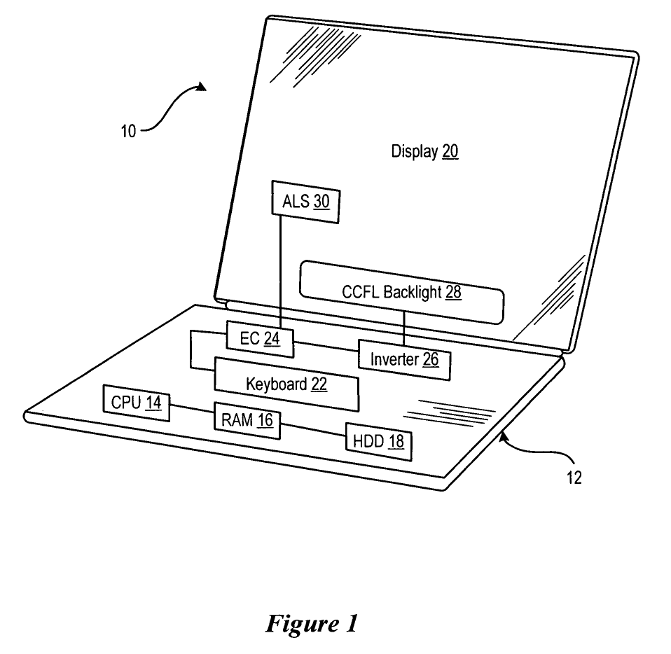

Referring now to FIG. 1, a block diagram depicts an information handling system 10 having a display with ambient light brightness correction. Information handling system 10 is configured as a portable system having plural processing components disposed in a housing 12, such as CPU 14, RAM 16 and hard disk drive 18, and having an integrated display 20. A keyboard 22 integrated in housing 12 accepts user inputs with an embedded controller (EC) 24 converting keyboard inputs for use by the processing components. Embedded controller 24 also manages the brightness of display 20 by managing a display power output by an inverter 26. Inverter 26 outputs variable power levels to a backlight 28, such as a CCFL light that illuminates LCD pixels of display 20. An ambient light sensor 30 detects the ambient light level proximate display 20 and provides the detected ambient light level to embedded controller 24. Embedded controller 24 has firmware that automatically adjusts the brightness output from display 20 to compensate for the detected ambient light level. For instance, moving display 20 from indoors to outdoors increases the detected ambient light level resulting in embedded controller 24 commanding increased brightness output from inverter 26.

In addition to automated adjustments in response to detected ambient light, embedded controller 24 accepts manual user brightness selections and performs automated user brightness preference adjustments. Manual brightness adjustments are made by the user through keyboard 22 to further increase or decrease the brightness commanded by embedded controller 24. For instance, each selection of control and an up arrow on keyboard 22 incrementally increases display brightness above the brightness level set in response to the detected ambient light level. Firmware of embedded controller 24 analyzes the manual user adjustments to establish a user brightness preference for the detected ambient light level. The user brightness preference automatically establishes the user's manually input brightness level for the display brightness if a similar level of ambient light is detected in a subsequent use of display 20. Note that in alternative embodiments, the brightness management functions performed by the embedded controller may be instead incorporated into inverter 26 or in other processing components.

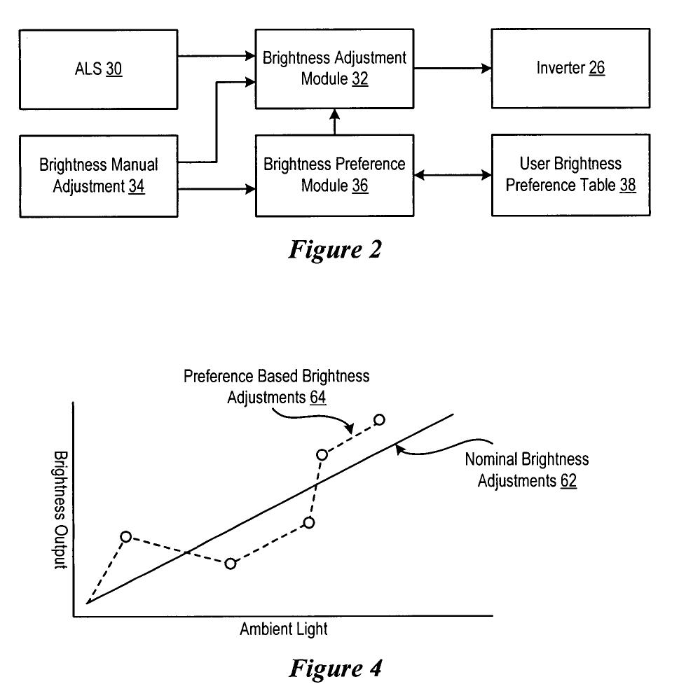

Referring now to FIG. 2, a block diagram depicts a system for adjusting display ambient light brightness correction for user brightness preferences. A brightness adjustment module 32 receives detected ambient light levels from ambient light sensor 30 to determine the brightness level output by inverter 26. For instance, as ambient light increases the output of inverter 26 is increased and as ambient light decreases the output of inverter 26 is decreased. In addition, brightness adjustment module 32 increases or decreases the brightness level output from inverter 26 in response to manual user brightness adjustments 34. Thus, a predetermined brightness level output at an associated ambient light level is further adjusted according to manual incremental changes input by a user, such as with the control and arrow keys. A brightness preference module 36 interfaces with brightness manual adjustments 34 to analyze a user's brightness preferences and stores those preferences in a user brightness preference table 38. Brightness preference module 32 then applies the user brightness preferences to adjust the brightness output determined by brightness adjustment module 32 for various levels of detected ambient light.

As an example, brightness adjustment module 32 has predetermined display brightness levels associated with each of plural detected ambient light levels. When the display is powered on and an ambient light level is detected, brightness adjustment module 32 commands a brightness output from inverter 26 that is associated with the detected ambient light level. Brightness manual adjustments 34 input by a user change the brightness level commanded by brightness adjustment module 32, each incremental manual input having a corresponding incremental change in brightness. Brightness preference module 36 determines the difference between the predetermined brightness for the detected ambient light level and the user's manually selected brightness preference and stores that value in user brightness preference table 38. When, in a subsequent use of the system, the same ambient light level is detected, brightness preference module 36 automatically adjusts the output of brightness adjustment module 32 to compensate for the user preference that was previously manually selected at that ambient light level. In one embodiment, brightness preference module 36 analyzes user brightness preferences by storing user preferences manually input by a user for each of plural detected ambient light levels. In an alternative embodiment, brightness preference module 36 predicts user brightness preferences by applying a model to historical manual brightness adjustments made by a user. In yet another embodiment, brightness preference module 36 allows direct access by a user to user brightness preference table 38 so that the user may directly input the user's brightness preferences at various detected ambient light levels.

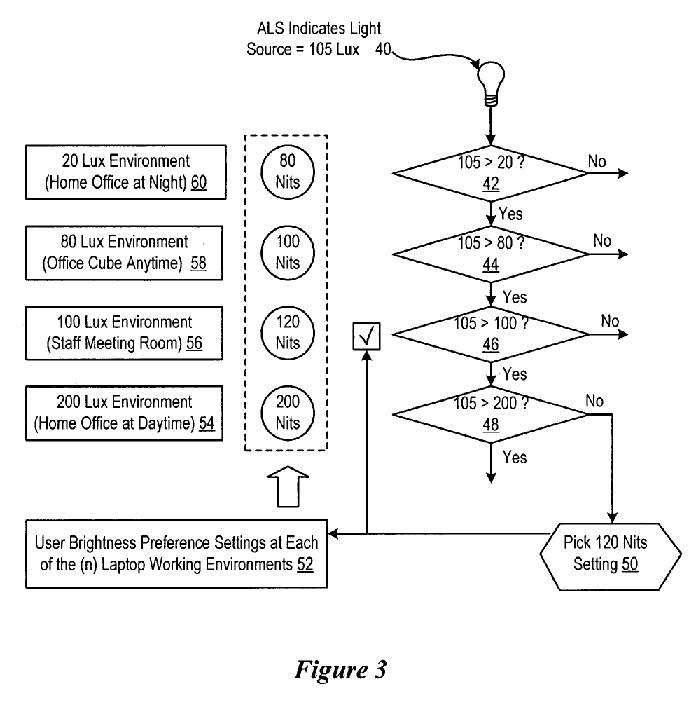

Referring now to FIG. 3, a functional block diagram depicts an example of an automated user brightness preference adjustment to a display having ambient light correction. The adjustment process begins at step 40 with a measurement of the ambient light at 105 Lux. The process steps incrementally through stored user preferences at step 42 of 20 Lux, at step 44 of 80 Lux, at step 46 of 100 Lux until, at step 48 a determination is made that the detected ambient light is less than 200 Lux. At step 50, a look up is made to determine the brightness of 120 nits associated with sensed ambient light in excess of 100 Lux but less than 200 Lux. The process continues to step 52 for setting of the display brightness with the 120 nit setting for the sensed ambient light of 105 Lux. As is depicted by FIG. 3, different lighting environments are associated with varying user brightness preferences through the ambient light detected at each environment. At step 54, a 200 Lux environment has a 200 nit setting, a 100 Lux environment has a 120 nit setting, an 80 Lux environment has a 100 nit setting and a 20 Lux environment has a 80 nit setting. Brightness settings in various ambient light environments may be stored as output values or as variances to the output value otherwise automatically selected for a given ambient light level. For instance, FIG. 4 depicts nominal brightness adjustments 62 which have a substantially linear relationship to detected ambient light. Preference based brightness adjustments 64 have a non-linear relationship relative to the detected ambient light with the user preferences for various levels of ambient light changing the brightness output compared with the nominal ambient light brightness adjustment.

Although the present invention has been described in detail, it should be understood that various changes, substitutions and alterations can be made hereto without departing from the spirit and scope of the invention as defined by the appended claims.

What is claimed is:

1. An information handling system comprising:
plural processing components operable to generate visual information;
a display operable present the visual information;
an ambient light sensor proximate the display and operable to detect ambient light at the display;
a brightness adjustment module interfaced with the display and the ambient light sensor, the brightness adjustment module operable to automatically apply predetermined brightness adjustments at the display in response to the detected ambient light and to manually adjust the brightness of the display in response to user brightness inputs; and
a brightness preference module interfaced with the brightness adjustment module and operable to automatically alter the predetermined brightness adjustments in response to user brightness preferences.

2. The information handling system of claim 1 wherein the brightness preference module alters the predetermined brightness adjustments by analysis of manual user brightness adjustments.

3. The information handling system of claim 2 wherein the predetermined brightness adjustments have a substantially linear relationship with ambient light and the altered predetermined brightness adjustments have a substantially non-linear relationship with ambient light.

4. The information handling system of claim 1 wherein the brightness preference module alters the predetermined brightness adjustments according to settings manually selected by a user.

5. The information handling system of claim 1 wherein the processing components comprise an embedded controller, the brightness preference module residing in firmware of the embedded controller.

6. The information handling system of claim 1 wherein the processing components comprise an inverter operable to output variable brightness to the display, the brightness preference module residing in firmware of the inverter.

7. The information handling system of claim 1 wherein the brightness preference module comprises a model operable to predict a user brightness preference for a detected ambient light based on historical user brightness preference inputs.

8. A method for displaying information from an information handling system, the method comprising:
illuminating a display with a brightness;
detecting an ambient light level proximate the display;
automatically adjusting the brightness in response to the detected ambient light level; and
automatically adjusting the brightness in response to a user brightness preference associated with the detected ambient light level.

9. The method of claim 9 further comprising:
accepting a user input to manually adjust the brightness; and
changing the user brightness preference associated with the detected ambient light according to the user input.

10. The method of claim 8 further comprising:
detecting a change in the ambient light level;
automatically adjusting the brightness in response to the change in the ambient light level; and
automatically adjusting the brightness in response to a user brightness preference associated with the changed ambient light level.

11. The method of claim 8 further comprising:
storing plural user brightness preferences at the information handling system, each user brightness preference associated with an ambient light level.

12. The method of claim 11 further comprising:
receiving the plural user brightness preferences from manual user selections.

13. The method of claim 11 further comprising:
receiving plural user inputs to manually adjust the brightness from plural automatically adjusted brightness levels; and
automatically analyzing the user inputs to generate the plural user brightness preferences.

14. The method of claim 13 wherein automatically analyzing further comprises applying plural user inputs to a model to predict the plural user brightness preferences.

15. A system for selecting display brightness levels, the system comprising:
an ambient light sensor operable to detect an ambient light level proximate the display;
a brightness adjustment module interfaced with the ambient light sensor and operable to output a brightness level adjusted to the detected ambient light level;
plural user brightness preferences, each user brightness preference associated with an ambient light level; and
a brightness preference module interfaced with the brightness adjustment module and operable to adjust the brightness level according to the user brightness preference associated with the detected ambient light level.

16. The system of claim 15 wherein the brightness adjustment module adjusts brightness in a substantially linear relationship to detected ambient light and the user brightness preferences adjust brightness in a substantially non-linear relationship to detected ambient light.

17. The system of claim 15 wherein the brightness adjustment module is further operable to adjust the brightness level in response to manual user brightness inputs.

18. The system of claim 17 wherein the brightness preference module is further operable to monitor manual user brightness inputs at one or more ambient light levels and automatically generate one or more user brightness preferences at the one or more ambient light levels in response to the manual user brightness inputs.

19. The system of claim 17 wherein the brightness preference module is further operable to monitor manual user brightness inputs to predict the user brightness preferences for one or more ambient light levels.

20. The system of 15 wherein the brightness preference module is further operable to accept user selections for one or more user brightness preferences.
